(19) United States
(12) Patent Application Publication
(10) Pub. No.: US 2003/0115589 A1
(43) Pub. Date: Jun. 19, 2003

(54) System and method for automatically flagging a channel as a favorite channel

(76) Inventors: Errol D'Souza, Sicklerville, NJ (US); Francis D. Palazzo, Dresher, PA (US); Bruce Plotnick, Jamison, PA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/022,655

(22) Filed: Dec. 17, 2001

(51) Int. Cl. H04N 7/16; H04H 9/00; G06F 3/00; H04N 5/445; G06F 13/00

(52) U.S. Cl. 725/10; 725/9

(57) ABSTRACT

The present invention comprises a system, method and software for automatically flagging one or more channels broadcast over a distribution network as a favorite channel that comprises monitoring input commands by a user through the use of an input device to detect a command from the user to tune a channel. An identifier for the channel is recorded and an indicator of the number of times that the channel has been tuned is incremented. The identifiers with the top indicators are selected for inclusion within the list of automatic favorite channels.

### RELATED APPLICATION

This application is related to commonly owned provisional application entitled “SYSTEM AND METHOD FOR DIGITAL TV NAVIGATOR AND EPG”, attorney docket No. 4665/4, Ser. No. 60/______, said application filed on Dec. 13, 2001 and hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to navigation within digital information systems. More particularly, the present invention relates to a system and method for automatically flagging a list of favorite channels and providing navigation therefor.

Various audio/video navigation and electronic program guide systems are known to those skilled in the art. These systems typically provide some degree of interactive functionality whereby advanced features are made available to a user of such a system. For example, electronic program guides are provided whereby a user may explore programming available on one or more channels distributed on a particular delivery system at a variety of future times. Likewise, supplemental programming information may be provided to users as they navigate among the channels that supply the available programming.

Another feature made available by some of these systems is the ability to store one or more channels as favorite channels whereby navigation between channels may be limited to only those channels flagged as favorites. Unfortunately, indicating to the system those channels that are favorite channels can be a time consuming process requiring the user to tune each channel that they wish to include in a favorites list and mark it as such. Furthermore, a user may spend a significant amount of time viewing a particular channel but nonetheless fail to flag it as a favorite channel. Moreover, channels chosen by a user as favorite channels may change over time as programming selections change on those and other channels.

There is thus a need for a system and method whereby favorite channels may be automatically flagged and easily accessible to a user.

### BRIEF SUMMARY OF THE INVENTION

The invention presented herein comprises a system, method and software for automatically flagging one or more channels broadcast over a distribution network as a favorite channel. The method of the present invention comprises monitoring input commands by a user through the use of an input device to detect a command from the user to tune a channel. For example, a user may enter an input command to tune a channel by directly entering the channel number to tune to or by selecting the channel through an electronic program guide. An identifier for the channel is recorded and an indicator of the number of times that the channel has been tuned is incremented. The identifiers with the top indicators are selected for inclusion within the list of automatic favorite channels. According to some embodiments of the invention, the channel service is tracked as the channel identifier as opposed to the channel number. The channel service refers to the entity broadcasting programming on a particular channel number, e.g., Home Box Office. When the channel map for a particular distribution system changes, e.g., the mapping of services to channel numbers, the automatic favorite list continues to faithfully reflect the appropriate channels.

The identifier and indicator for the tuned channel may be compared to the list of automatic favorite channels to determine if the indicator is greater than any indicator in the list of automatic favorite channels. Where the indicator is greater than any indicator comprising the list of automatic favorite channels, the identifier and indicator are added to the list of automatic favorite channels. Any identifier whose indicator falls beyond a view threshold is removed from the list of automatic favorite channels. The view threshold value for determining whether a channel is included in the list of automatic favorite channels comprises the indicators of the N^{th} highest channels, e.g., the tenth indicator in the top ten indicators. Alternatively, the system and method of the present invention may use a combination of the number of times a user accesses a particular channel and the amount of time spent viewing the channel. According to this embodiment, the indicator may be a single value derived from the number of times a channel is viewed in conjunction with the time that the channel was viewed or may be multiple distinct values associated with each channel identifier.

Functionality is provided whereby the user may manually override certain features of the automatic favorites list. According to one embodiment, functionality is provided that allows the user to set up certain channels that are always marked as favorite channels. As the user navigates programming presented, the invention continually tracks identifiers for the channels viewed and, according to some embodiments, the amount of time each channel is viewed. The system determines whether the channel is a favorite channel, e.g., by determining if the number of times the channel has been watched falls within a particular threshold, and marks channels as a favorite channel as described in detail herein.

According to other embodiments, the view threshold value for determining whether a channel is included in the list of automatic favorite channels comprises setting the threshold to a user defined value. The view threshold value for determining whether a channel is included in the list of automatic favorites may also comprise setting the threshold to a value set dynamically by a content service provider. In keeping with other embodiments of the invention, a mechanism is provided for “aging” any channels automatically as favorite channels. Accordingly, when a user has failed to view a channel for a number of days that exceeds a threshold value, the indicator for the particular channel may be decremented and removed from the list of automatic favorites as is appropriate for the channel after decrementing the number of views. For example, where a user does not view a particular channel for a twenty-four hour period, the indicator for that channel is decremented by a value of one.

The method of automatically flagging one or more channels broadcast over a distribution network as a favorite channel may also comprise the steps of comparing a duration that the channel is viewed to a time threshold. An identifier is recorded for the channel and the indicator of the number of times the channel has been tuned is incremented when the channel is viewed for a duration that is greater than the time threshold.

The input device used by the user to issue commands may comprise controls to navigate the favorite channel list. Accordingly, the method presented herein may comprise selecting a favorite control on the input device to traverse the list of automatic favorite channels. The navigation controls may also be used to traverse the automatic favorite list one channel each time the control is selected.

The automatic favorite channel list may be incorporated within an electronic program guide, the electronic program guide operative to present programming information regarding programming being broadcast on the distribution network. Accordingly, an electronic program guide is displayed. The scope of information presented by the electronic program guide is limited in scope to programming available on channels comprising the automatic favorite list. Guide data may be received, the guide data comprising information regarding programming available on the distribution network, and programming information regarding to programs comprising the automatic favorite channel list extracted for presentation within the electronic program guide. The step of displaying the electronic program guide may comprise presenting a full screen program guide comprising listing of programming available on the distribution network. The full screen guide may comprise audio and video associated with the channel viewed before the guide is displayed.

The methods of the present invention may be embodied in computer readable media comprising program code. The program code is capable of being executed by a programmable microprocessor to perform a method for automatically flagging one or more channels broadcast over a distribution network as a favorite channel. The program code comprises a method that comprises monitoring input commands by a user through the use of an input device to detect a command from the user to tune a channel. An identifier is recorded for the channel and an indicator of the number of times the channel has been tuned is incremented. Identifiers with the top indicators are selected for inclusion within the list of automatic favorite channels.

The present invention also contemplates systems for automatically flagging one or more channels broadcast over a distribution network as a favorite channel. A system for accomplishing this comprises means for monitoring input commands by a user through the use of an input device to detect a command from the user to tune a channel. Means are also provided for recording an identifier for the channel and incrementing an indicator of the number of times the channel has been tuned and selecting identifiers with the top indicators for inclusion within the list of automatic favorite channels.

Another system for automatically flagging one or more channels broadcast over a distribution network as a favorite channel comprises a channel list and view count data structure comprising a listing of channels viewed by a user and the number of times each channel has been tuned. Also provided is favorite selection software. The favorite selection software is used to record an identifier for a channel and increment an indicator of the number of times the channel has been tuned. The identifier and indicator are stored in the channel list and view count data structure by the software. The favorite selection software is operative to select recorded identifiers with the top indicators for inclusion within a list of automatic favorite channels.

The data structure and software may be stored on a memory of a set top terminal connected to the distribution network. According to some embodiments, the channel list and view count data structure is stored on a DRAM memory module, the list of automatic favorite channels is stored on a NVRAM memory module, and the favorite selection software is stored on a flash memory module.

Consistent with embodiments of the invention, automatic favorites may be calculated for a user across all viewing sessions, as opposed to maintaining viewing statistics for a single session. Thus, channel identifiers and indicators regarding the number of times a particular channel has been viewed are stored for all channels viewed, preferably in a type of non-volatile memory module. The channels with the top indicators are set as the list of automatic favorites, e.g., the channels with the top ten indicators. Likewise, embodiments of the invention may be implemented by creating a plurality of automatic favorite lists whereby a different automatic favorite list is manipulated depending on the time of day or day of the week that the system is being accessed, for example, a different automatic favorite list on Tuesday morning from the one used on a Wednesday night.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a configuration of hardware and software components according to one embodiment of the present invention;

FIG. 2 is a block diagram presenting an alternative configuration of hardware and software components according to another embodiment of the present invention;

FIG. 3 is a high-level flow diagram presenting a process for automatically flagging favorite channels according to one embodiment of the present invention;

FIG. 4 is a detailed flow diagram presenting a process for automatically flagging favorite channels according to one embodiment of the present invention; and

FIG. 5 is a flow diagram presenting a process for tuning using an automatically or manually constructed favorite channel list.

### DETAILED DESCRIPTION OF THE PREFERRED EMBODIMENTS

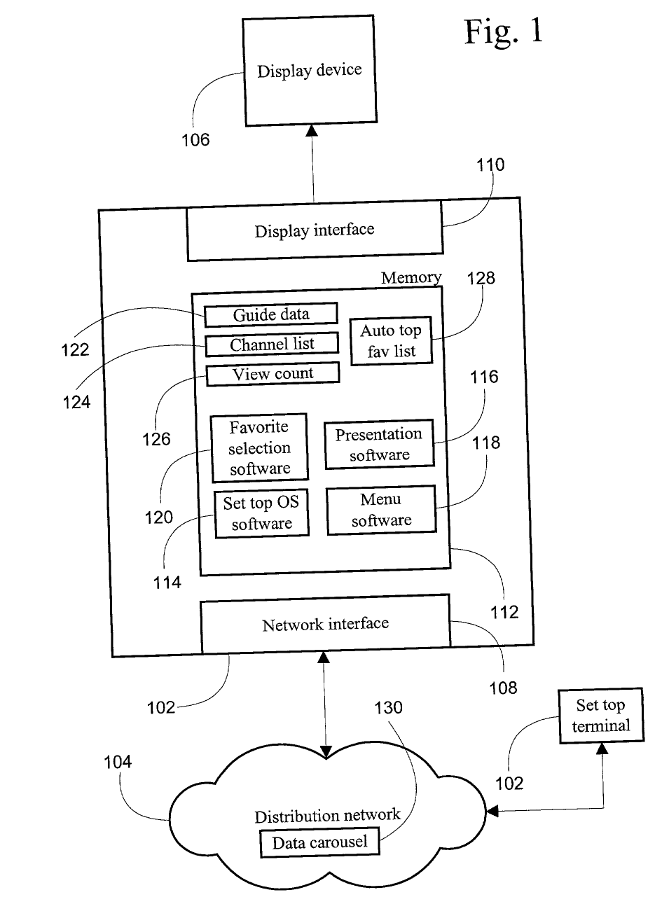

With reference to FIGS. 1 through 5, embodiments of the instant invention are presented. One embodiment of a configuration of hardware and software components of the invention is presented in FIG. 1. A distribution network 104 is used to distribute digital and/or analog audio and video data to one or more subscribing customers' set top terminal 102. According to some embodiments, the distribution network 104 comprises a coaxial infrastructure, a fiber infrastructure, a hybrid fiber-coax infrastructure, a wireless infrastructure, or a combination of these and other delivery technologies well known to those skilled in the art. Audio and video data is transported across the distribution network 104 to a subscriber's set top terminal 102, where the data is received over the terminal's network interface 108. Exemplary set top terminals include the DCT1000, DCT1200 and DCT2000 manufactured by General Instruments, or any other set top terminal or receiver as are well known to those skilled in the art.

Software 114, 116, 118, and 120 stored in memory 112 on the set top terminal 102 is used by a programmable digital microprocessor (not pictured) to decode and present the audio and video data received from the distribution network 104 across a display interface 110 on a display device 106. Software components used to present audio and video data, as well as advanced navigation and EPG features of the present invention include set top OS software 114, presentation software 116, menu software 118, and favorite selection software 120. Set top operating system software 114 is used to provide the core operating system functionality of the set top terminal 102, such as basic input/output and other low-level functions. The OS software 114 also provides a framework for executing application program code, e.g., presentation 116, menu 118, and favorite selection 120 software.

The set top presentation software 116 is used to present navigation tools and electronic program guide (EPG) functionality to the set top terminal user. The presentation software 116 fetches and displays scripts, which are pages of content, used to construct an electronic program guide. The scripts are retrieved from a data carousel 130 located on the distribution network in response to user commands. Alternatively, the data carousel 130 is located at a cable head end and broadcast across the distribution network 104. As a user manipulates an input device to request additional program guide content, the presentation software 116 fetches the appropriate script from the data carousel 130 for presentation on the display device 106. According to some embodiments, the presentation software 116 presents the EPG on the display device as a full screen guide. The full screen guide is displayed as an overlay on top of programming currently being viewed when the guide is accessed. Alternatively, the full screen guide is a displayed as a separate screen presented in place of the programming currently being viewed when the guide is accessed. The presentation software 116 may also be configured to display the EPG along with audio and video data being transmitted on the last channel viewed before activating the EPG.

In addition to EPG functionality, the presentation software 116 provides navigation tools in the form of a surf guide that is displayed to the user each time a channel is tuned. Advantageously, the presentation software 116 may display the surf guide as an overlay on top of the currently tuned program for a predetermined or variable number of seconds. In keeping with some embodiments, data 122 for the surf guide generated by the presentation software 116 is retrieved from the distribution network 104 on a periodic basis, e.g., upon exceeding a time threshold after the set top power has been cycled on. This data is stored in the set top memory 112 as guide data 122, which is used to populate the displays generated by the presentation software 116. The surf guide presents data 122 that comprises channel number and network identifier, program title, program start and end times, and other miscellaneous program data. According to some embodiments, the surf guide is presented in response to user selection of an appropriate control on the input device. The surf guide may be used in conjunction with directional controls, also located on the input device, to step through the guide data 122. Using the surf guide, the user may view information regarding future or past programming on the channel currently being viewed or other channels that comprise the channel map for the subscribers distribution system.

Menu software 118 is stored in the set top terminal's memory 112 and provides a menu-based interface for configuring the present system. Menu software 118 responds to commands provided by the user through the use of an input device (not pictured). Through the menu interface provided by the menu software 118, a user able to customize features of the operating system 114 and presentation software 116, as well as other software components resident on the set top terminal 102. For example, using the menu software 118, a user is capable of setting parental passwords, setting purchase passwords, and locking or unlocking channels. The menu software 118 may also be used to generate lists of favorite channels, which may be activated and traversed by the user. Indeed, the menu software is constructed to allow configuration of all aspects of set top audio and video presentation, as well as the full screen and surf guides generated by the presentation software 116.

Also provided is a favorite selection software module 120, which is responsible for generating and managing an automatic favorite selection list 128. A user interacts with the set top terminal 102, through the use of navigation tools such as the surf guide and the full screen electronic program guide, to tune channels of programming delivered over the distribution network 104. As a channel is tuned, the favorite selection software 120 automatically stores an instance of the channel impression in memory 112 by recording the channel identifier in a channel list 122. According to some embodiments of the invention, the channel service is tracked as the channel identifier as opposed to the channel number. The channel service refers to the entity broadcasting programming on a particular channel number, e.g., Home Box Office. When the channel map for a particular distribution system changes, e.g., the mapping of services to channel numbers, the automatic favorite list continues to faithfully reflect the appropriate channels.

A corresponding view count data file 124 is also generated in memory 112 to maintain the number of impressions for each channel. A predetermined number of top channels, defined as the several channels with the greatest number of views recorded in the view count file 126, is written to an automatic top favorites list data file 128. When no favorite channel list manually created by the user is activated and the user selects a favorite channel navigation control on the input device, the automatic favorite list 128 automatically generated by the favorite selection software 120 is traversed, one channel for each time the control is selected.

As those skilled in the art recognize, the software components of the present invention 114, 116, 118, and 120 may be created using a variety of programming languages, paradigms, and tools. These software components may be presented as a single, unified software component or, alternatively, broken into additional functionally targeted software components according to various embodiments of the invention. Furthermore, the data files presented herein 122, 124, 126, and 128 may be implemented utilizing any number and type of data structures. Exemplary data structures include, but are not limited to, tab delimited files, comma delimited files, tables within a relational database, objects within an object oriented database, or structures within a hybrid relational-object database.

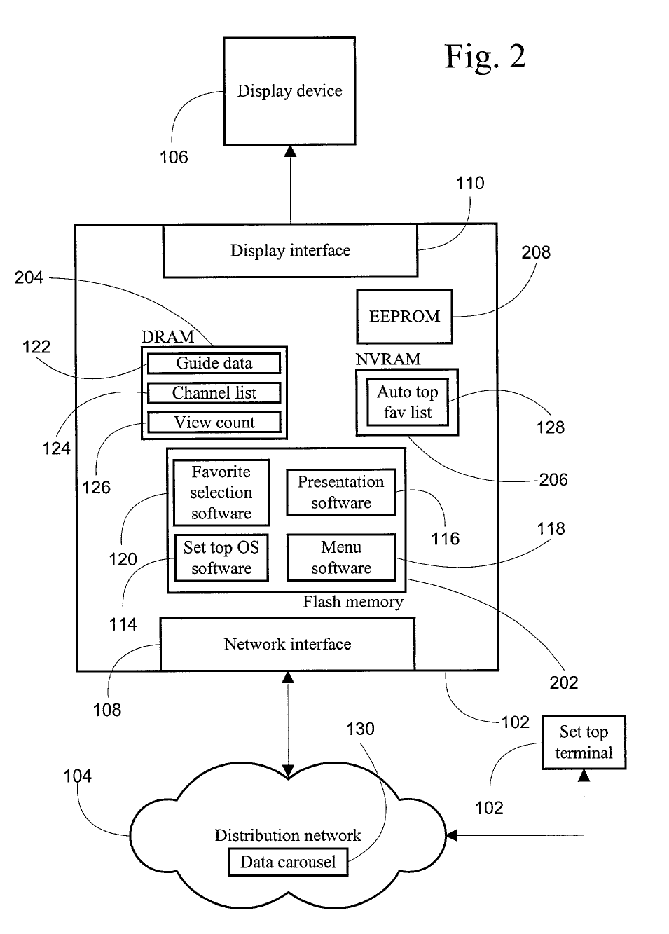

FIG. 2 presents an alternative embodiment of the system presented in FIG. 1 utilizing a plurality of disparate memory types to maintain the software and data comprising the present system. As with the system of FIG. 1, audio and video content is transmitted across a distribution network 104 to one or more set top terminals 102. The terminal 102 receives audio and video content via a network interface 108 where it is tuned and decoded by the set top terminal according to user commands received from an input device, such as a remote control or wireless keyboard (not pictured). The terminal 102 transmits tuned channels across a display interface 110 to a display device 106 for viewing by the user.

According to this embodiment of the invention, software components used to support the system 114, 116, 118, and 120 are stored on a flash memory module 202. Flash memory, also referred to as flash RAM, is a type of constantly powered nonvolatile memory that can be erased and reprogrammed in units of memory called blocks. When code stored on the flash memory 202 needs to be rewritten, it can be written in blocks as opposed to bytes, making updates faster and easier. In this manner, software components on the terminal are easily erased or “flashed” from the memory. Updates to one or more of the software components may be transmitted from a system operator, e.g., cable headend, via the data carousel 130 and written to the flash memory 202.

DRAM memory 204 is provided as temporary storage for data files generated and/or manipulated by the software components of the system. DRAM (Dynamic RAM) stores each bit in a storage cell consisting of a capacitor and a transistor. This type of memory is referred to as “dynamic” because the capacitors tend to lose their charge rather quickly and therefore require recharging every few milliseconds in order to retain their information. As described above, guide data 122 is periodically retrieved from the distribution network in order to provide data to the presentation software when generating the surf guide. Favorite selection software 120 also stores the channels viewed by the user and a count of the number of times each channel is viewed. DRAM memory is used for the storage of these files as the data contained therein is typically relevant only to one viewing session, e.g., there is no need to retain the data when the set top terminal is powered down.

The automatic favorites list 128 is preferably stored in a non-volatile random access memory module (NVRAM) 206, in order to preserve a user's favorite channels as manifested by their viewing behavior between viewing sessions. NVRAM is a form of static random access memory whose contents is saved when a computing device is turned off or loses a connection to its power source. NVRAM may be implemented by providing static RAM with backup battery power. Alternatively, the contents of the RAM module may be saved to an electrically erasable programmable read-only memory module (EEPROM) 208 whereby the contents of the EEPROM are rewritten to the NVRAM or other type of RAM upon restoration of external power. The inclusion of an EEPROM 208 as part of the system is valuable as a storage location to maintain information between viewing sessions, e.g., system preferences.

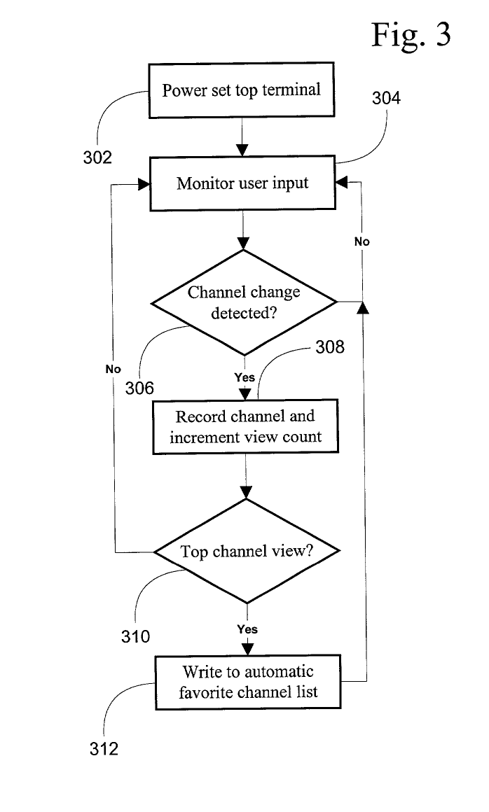

A high level method of automatically selecting a user's favorite channels using embodiments of the system introduced in FIGS. 1 and 2 is presented in FIG. 3. The method is initiated when the set top terminal is powered on, step 302. Upon powering up the terminal, the OS and other software components are initiated and data structures used to maintain channel and view counts are initialized to zero. Specifically, the favorite selection software is initiated to automatically track a user's favorite channels as manifested by their viewing behavior. The OS, favorite selection, and other software components of the system are initiated and the favorite selection software monitors any user input performed by the user using the input device, step 304.

As the favorite selection software monitors commands provided by the user to the system, a check is performed that determines if the user has instructed the set top to change the channel, e.g., tuned to a channel different from the current channel or selected a channel through an electronic program guide, step 306. Where the check resolves to false, e.g., no channel change was made, processing returns to step 304 where the favorite selection software continues to monitor user input. Where the software detects that a channel change command has been received from the user at the set top, step 306, the identifier for the channel that the user has tuned to is written to memory, step 308. Additionally, the number of times that the user has tuned the selected channel is incremented in memory, step 308.

The tuned channel and view count are recorded, step 308, and another check is performed to determine if the tuned channel is a top viewed channel, step 310. According to one embodiment, the check, step 310, evaluates to true if the channel is among the set of channels with the top ten view counts. According to another embodiment, the threshold to determine whether a channel is a top viewed channel may be supplied by the user, e.g., through the use of the previously described menu software. Alternatively, the threshold may be dynamically set by the content service provider, e.g., at the cable headend, and delivered to the user through the data carousel over the distribution network or within the set of data periodically downloaded to the set top terminal in order to drive the surf guide.

Where the check to determine whether the channel the user tunes is one of the top channel views returns false, step 310, programming flow returns to step 304 where the favorite selection software continues to monitor for user input. If the check returns true, step 310, the channel satisfies the threshold used to determine whether the channel is among the top viewed channels. The favorite selection software writes the channel and view count data for the selected channel to the automatic favorite channel list, step 312. Programmatic flow returns to step 304 where the favorite selection software continues to monitor for user input.

According to embodiments of the invention, the calculation or generation of the automatic favorites list is performed off-line or in a batch mode. Controls are provided to the user, for example though the menu interface, whereby the user may set a mode that defines when the system calculates the automatic favorites list. Accordingly, the system continues to monitors a user's viewing habits, recording channel identifiers and incrementing the number of times a channels has been viewed as the channel is tuned by the user. Depending on the mode selected by the user, the calculation to determine whether a channel is a top viewed channel is performed, for example, in a batch when the set top terminal's power is cycled off, in response to a command from the user to force the calculation, or when the system detects that it has been idle for a period of time (which itself may also be set by the user).

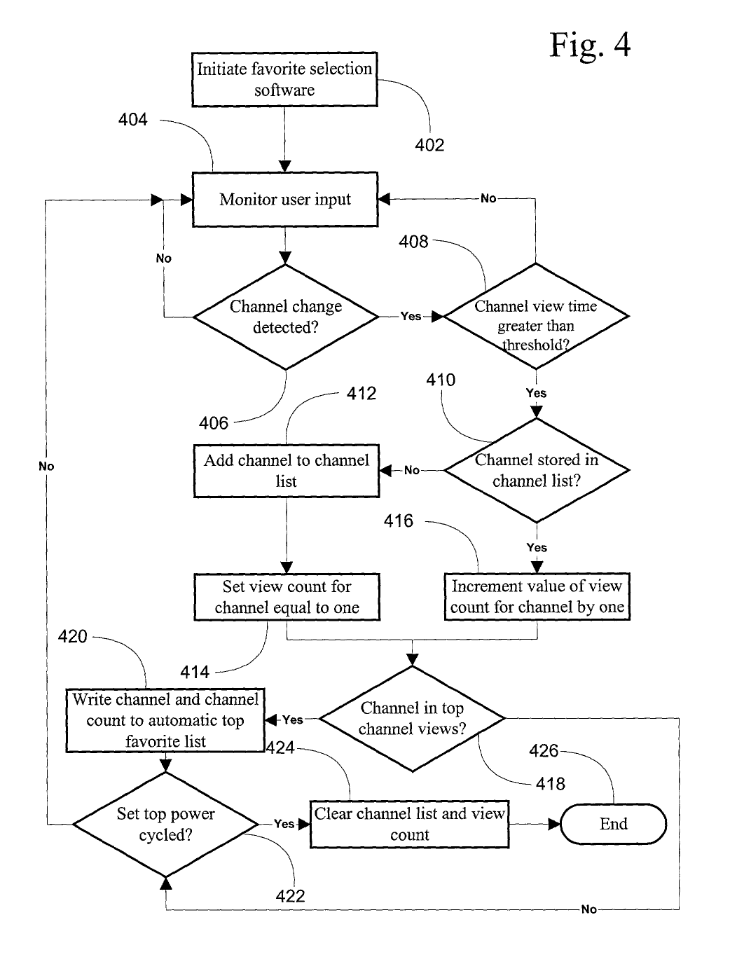

Turning to FIG. 4, a flow diagram illustrating an alternative embodiment of a method for automatically selecting a user's favorite channels using embodiments of the system introduced in FIGS. 1 and 2 is presented. The method is initiated when the set top terminal is initially powered on, initiating the OS and other software components of various embodiments of the system, step 402. Specifically, the favorite selection software is initiated to automatically track a user's favorite channels, step 402. Once loaded, the favorite selection software monitors user input performed by the user through manipulation of the input device, step 404.

The favorite selection software monitors commands provided by the user to the system and a check is performed to determine if the user has instructed the set top to change the channel, e.g., tuned to a channel different from the current channel, step 406. Where the check resolves to false, e.g., no channel change was made, processing returns to step 404 where the favorite selection software continues to monitor user input. If the software detects that a channel change command has been received from the user at the set top, step 406, the software performs another check and determines whether the channel view time is greater than a threshold time, step 408.

According to one embodiment, the check, step 408, evaluates to true if the user views the channel for more than two seconds. According to another embodiment, the time threshold to determine whether a channel has been viewed, rather than simply surfed over, is supplied by the user, e.g., through the use of the previously described menu software and an input device. Alternatively, the time threshold may be set by the cable service provider and delivered to the user through the data carousel on the distribution network or within the set of data periodically downloaded to the set top terminal in order to drive the surf guide. Where the view time does not exceed the time threshold, step 408, processing returns to step 404 where the favorite selection software monitors user input performed by the user through manipulation of the input device. If the channel view time exceeds the view time threshold, channel and view count data is written to memory.

When channel and view count data is to be written to memory, e.g., the check performed in step 408 returns true, the favorite selection software determines whether the viewed channel is stored in the channel list, step 410. Where the channel is not stored in the channel list, step 410, the channel is added to the channel list, step 412. Because the channel is not stored in the channel list, step 410, there is no view count data. The view count for the channel is therefore set to one, step 414. If the software locates the channel in the channel list, step 410, the value for the channel's view count is incremented by a value of one, step 416.

Processing continues at step 418 where a check is performed to determine whether the channel is among the top channel views. According to one embodiment, the check, step 418, evaluates to true if the channel is among the set of channels with the top ten view counts by comparing the channel indicator count to the ten highest counts as previously recorded. According to another embodiment, the threshold to determine whether a channel is a top viewed channel may be supplied by the user, e.g., through the use of the previously described menu software. Alternatively, the view threshold may be set by the content service provider and delivered to the user through the data carousel on the distribution network or within the set of data periodically downloaded to the set top terminal in order to drive the surf guide. According to still another embodiment, all channels that are recorded by the system as having been viewed by the user are ordered according to the number of times each channel has been viewed. The check performed at step 418 evaluates to true where channel is within a set of top viewed channels, e.g., the top ten channels.

If the channel is not within the set of top viewed channels, step 418, programmatic flow returns to step 422 where a check is made to establish if the set top power is cycled. Where the set top terminal is powered down, the channel list and view count data are cleared from memory, step 424, and processing concludes, step 426. If the set top power has not been cycled, the favorite selection software returns to step 404 and continues to monitor user input. If the check performed at step 418 determines that the channel is among the top viewed channels, the favorite selection software writes the channel and view count data for the selected channel to the automatic favorite channel list, step 420, and programmatic flow continues at step 422 as described above.

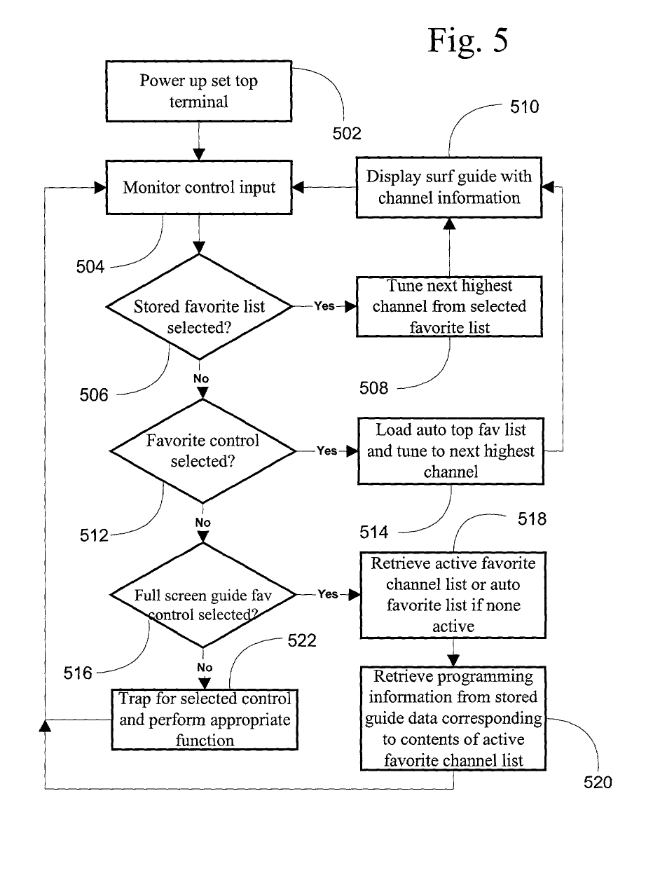

According to some embodiments of the invention, the system and method for automatically flagging a channel as a favorite channel is used in conjunction with television navigation and electronic program guide software, e.g., presentation software. FIG. 5 presents one embodiment of a method for using the automatic favorites list in such an environment. Processing begins when the set top terminal is powered on and software components for automatic favorites selection, presentation software, menu software, operating system and other software components are loaded or initiated, step 502.

The software components monitor the input control commands entered into the system by the user through an input device, e.g., keyboard or wireless mouse in conjunction with a graphical interface, step 504. A check is performed to determine whether the user has instructed the system to load a stored favorite list, step 506, which was previously manually constructed by the user. The selected stored favorite list is loaded and the set top tunes to the next highest channel from the current channel as indicated by the favorite list, step 508. Alternatively, the set top may tune to the next highest ranked channel from the current channel. Additionally, the presentation software displays a surf guide on the display device with channel information extracted from the set of guide data periodically retrieved from the distribution network, step 510. According to some embodiments, the system is aware that the tuned channel is part of a stored favorite list and displays an informative icon indicating this fact.

Where a stored favorite list is not selected, step 506, a check is performed to determine whether the user has selected a favorite control using the input device, step 512. Because no stored favorite list has been selected, the automatic top favorite list is loaded and the set top tunes to the next highest channel in the automatic top favorite list from the currently tuned channel, step 514. The channel from the automatic top favorites list is tuned and the presentation software displays a surf guide on the display device with channel information extracted from the set of guide data periodically retrieved from the distribution network, step 510. According to some embodiments, the system is aware that the tuned channel is part of a stored favorite list and displays an informative icon indicating this fact.

If the user does not select either a previously created favorite list or the favorite control, steps 506 and 512, a check is performed to determine whether the user has activated the favorite view control from within the full screen guide, step 516. The active favorite channel list is retrieved, step 518. Where there is no favorite channel list currently selected, the automatic top favorites list is retrieved. Current programming being transmitted on the channels comprising the active favorite channel list is retrieved from the stored guide data and presented to the user on the display device, step 520. Where all the previous checks resolve to false, steps 506, 512, and 516, the software components of the system trap the control string entered by the user and perform the appropriate function, step 522. The control initiated by the user is executed, steps 506, 512, 516, or 522, and program control returns to step 504 where the software components monitor the input control strings entered into the system by the user through an input device.

Other embodiments of the invention are tailored to account for multiple users of the set top terminal. Each user of the system is provided with a logon identifier, preferably a unique identifier. When initially accessing the set top terminal, the user's logon identifier is supplied to the system. Accordingly, a channel list and view count data structures are generated for the specific logon, with each login associated with an different set of data files. Likewise, each logon is associated with an individual automatic favorite list that is loaded when the user logs onto the system. Using this configuration, an automatic favorite list is maintained for each user of the system, thereby providing a personalized automatic favorite list functionality.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention.

What is claimed is:

1. A method for automatically flagging one or more tunable channels broadcast over a distribution network as a favorite channel, the method comprising:
monitoring commands input by a user through the use of an input device to detect a command from the user to tune a channel;
recording an identifier for the channel and incrementing a channel tune count indicator for the channel; and
selecting identifiers with the top indicators for inclusion within a list of automatic favorite channels

2. The method of claim 1 wherein the list of automatic favorite channels is associated with the identifier and indicator for each channel contained therein.

3. The method of claim 1 comprising:
recording the amount of time that the channel was viewed; and
selecting identifiers with the top indicators and view times for inclusion within the list of automatic favorite channels.

4. The method of claim 2 comprising:
comparing the identifier and indicator with the list of automatic favorite channels to determine if the indicator is greater than any indicator comprising the list of automatic favorite channels; and
adding the identifier and indicator to the list of automatic favorite channels where the indicator is greater than any indicator comprising the list of automatic favorite channels.

5. The method of claim 2 comprising removing from the list of automatic favorite channels any identifier that falls below a view threshold value.

6. The method of claim 5 wherein determining whether a channel is included in the list of automatic favorite channels comprises setting the view threshold value to an Nth highest indicator.

7. The method of claim 5 wherein determining whether a channel is included in the list of automatic favorite channels comprises setting the view threshold value to a user defined value.

8. The method of claim 5 wherein determining whether a channel is included in the list of automatic favorite channels comprises setting the view threshold to a value set dynamically by a content service provider.

9. The method of claim 1 comprising:
comparing a duration that the channel is viewed for against a time threshold; and
recording the identifier and incrementing the indicator when the channel is viewed for a duration greater than a time threshold.

10. The method of claim 1 comprising selecting a favorite control on the input device to traverse the list of automatic favorite channels.

11. The method of claim 9 wherein the list of automatic favorite channels is traversed one channel for each time the favorite control is selected.

12. The method of claim 10 wherein the list of automatic favorite channels is traversed during channel tuning by a user in order according to a rank of the channels in the list of automatic favorites.

13. The method of claim 1 comprising:
displaying an electronic program guide;
retrieving the list of automatic favorite channels;
limiting the scope of information presented by the electronic program guide to programming available on channels comprising the list of automatic favorite channels,

14. The method of claim 13 comprising:
receiving guide data comprising information regarding programming available on the distribution network;
extracting programming information relating to programs comprising the list of automatic favorite channels from the guide data for presentation within the electronic program guide.

15. The method of claim 13 wherein the step of displaying comprises displaying a full screen program guide comprising listings of programming available on the distribution network.

16. The method of claim 15 wherein the step of displaying comprises displaying a full screen program guide comprising audio and video associated with the channel viewed before the guide is displayed.

17. The method of claim 1 comprising:
determining a time of day and a day of the week;
based upon the date and time, selecting identifiers with the top indicators for inclusion within a time specific list of automatic favorite channels.

18. Computer readable media comprising program code, the program code capable of being executed by a programmable microprocessor, the program code comprising a method for automatically flagging one or more channels broadcast over a distribution network as a favorite channel, the method comprising:
monitoring commands input by a user through the use of an input device to detect a command from the user to tune a channel;
recording an identifier for the channel and incrementing a channel tune count indicator for the channel; and
selecting identifiers with the top indicators for inclusion within a list of automatic favorite channels.

19. A system for automatically flagging one or more channels broadcast over a distribution network as a favorite channel, the method comprising:
means for monitoring commands input by a user through the use of an input device to detect a command from the user to tune a channel;
means for recording an identifier for the channel and incrementing a channel tune count indicator for the channel; and
means for selecting identifiers with the top indicators for inclusion within a list of automatic favorite channels.

20. A system for automatically flagging one or more channels broadcast over a distribution network as a favorite channel, the system comprising:
a channel list and view count data structure comprising a listing of channels viewed by a user and the number of times each channel has been tuned;
favorite selection software to record an identifier for a channel and increment a channel tune count indicator for the channel, the identifier and indicator stored in the channel list and view count data structure, the favorite selection software operative to select recorded identifiers with the top indicators for inclusion within a list of automatic favorite channels.

21. The system of claim 20wherein the data structure and software is stored on a memory of a set top terminal connected to the distribution network.

22. The system of claim 20 wherein the channel list and view count data structure is stored on a DRAM memory module and the list of automatic favorite channels is stored on a NVRAM memory module.

23. The system of claim 20 wherein the favorite selection software is stored on a flash memory module.
